(19) United States
(12) Patent Application Publication
(10) Pub. No.: US 2009/0106084 A1
(43) Pub. Date: Apr. 23, 2009

(54) Market surveying

(75) Inventor: Amit Or, Mishmeret (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: inLive Interactive Ltd., Ra'anana (IL)

(21) Appl. No.: 11/918,499

(22) PCT Filed: Apr. 20, 2006
(86) PCT No.: PCT/IL2006/000476

§ 371 Date: Dec. 18, 2008

(30) Foreign Application Priority Data
Apr. 12, 2005 (IL) 167982

(51) Int. Cl. G06F 17/30; G06Q 30/00

(52) U.S. Cl. 705/10

(57) ABSTRACT

A Consumer Research Survey Management Apparatus comprising: a Survey Management Console interfaced with a Survey Participant Response Machine through which results of survey participation are collected and processed, and a method for holding surveys using the Consumer Research Survey Management Apparatus. The method comprises the steps of authoring a survey (Step I); determining whether the target population is ad-hoc or a set target (Step II); setting the survey schedule (Step III); activating the survey (Step IV); monitoring the survey in terms of its validity and integrity (Step V) monitoring participation levels (Step VI); optionally awarding incentives to survey participants (step VII); ensuring that the survey matches the research requirements in terms of population quotas (Step VIII) ensuring that the demographic profile of the survey participants matches the research requirements (Step IX); repeating at least part of the survey if necessary (Step X) and analyzing results (Step XI).

### FIELD OF THE INVENTION

The present invention is directed towards providing a method, apparatus and technological infrastructure for conducting market surveys, such as consumer research surveys for product testing, audience feedback regarding pilot TV-shows and commercials, and the like.

### BACKGROUND

The worldwide product research budget is in excess of $25 billion per annum. Four fifths of this is dedicated to consumer research, which may be quantitative or ad-hoc. The three dominant survey techniques are self-completion (˜40%), face-to-face surveying (˜20%) and telephone interviews (˜20%). These methods are expensive, with the cost of delivering a survey to a target population increasing approximately linearly with surveyed population size. The time required for identifying research objectives, organizing and carrying out a suitable survey, and receiving and analyzing the results is significant, and delays marketing of new products.

The surveyed target population is usually very limited with the above mentioned techniques. This is particularly the case with face-to-face interviews, and telephone interviews and self-completion is fraught with low response rates.

There is a need for more efficient survey methods. Such survey methods should interview large numbers of respondents to generate representative data. Ideally responses should be accumulated quickly and standard correlations and analyses should be easily accomplished.

There have been several attempts to address the need for improved survey technologies. U.S. Pat. No. 6,256,614 to Wecker et al. entitled “Internet system for producing electronic reward cards” relates to an electronic rewarding method for web site visitors, which involves transmitting reward refusal message to client if the reward has been previously issued for answering same inquiries. Essentially, a system to build and provide an immediate electronic reward to a consumer's PC, Web-TV, Pager, or other electronic media, in return for some action taken by the consumer on the Internet is described. Typically the reward is manifested in the image of an Electronic Phone Card that contains free long distance calling minutes. The amount of the reward and the nature of the accompanying marketing message (printed and audio) are built in real time according to the consumer's actions or answers to survey questions on the Internet, thus making this an “intelligent” system. Free long distance calling may be added to an existing card or may be delivered in the form of a new card.

The technology described is directed to web based surveys, where the content of the survey is directed to the user via the Internet and the user responds via his Internet browser. Practical experience with Internet based survey methods has been disappointing. Only consumers of a certain profile participate in Internet surveys. Many users surf the net for recreation or for work and are not interested in wasting their time in filling out surveys.

U.S. Pat. No. 4,816,904 to McKenna et al. entitled “Television and market research data collection system and method” relates to a TV market research data collection system that has remote data collection units storing data on TV viewing and purchase bar codes etc. for transfer to a central location. The data gathering system includes a plurality of remote units which are controlled from a central location. Each of the remote units is attached to a television receiver which is generally but not necessarily attached to a cable system. Each of the remote units can function to determine which of several TV modes is in use as well as to store TV channel selector data, data from an optical input device, and/or data input by viewers representative of the composition of the viewing audience. The data is stored; either for later collection by a portable data collector, or for direct transmission via a telephone to the central location. A video message for a TV viewer, such as a survey, may be transmitted from the central location and stored at the remote units, for later display on the TV receiver associated with the remote units. Substitution of alternate programming information may also be achieved by the central control point on selected of the remote units. The viewer responds to survey queries via the remote units of the TV. Drawbacks of such a system include the fact that only one viewer per enabled TV can participate. Special consumer hardware in the form of enabled TVs, having special remotes, and connected to the telephone network are required. The viewer must respond from his home TV, and cannot participate when traveling or at a friends.

U.S. Pat. No. 5,970,467 to Alavi entitled “An Accurate Market Survey Collection Method” describes a method for electronically accumulating market survey data from inherently interested Internet users or TV viewers. Various market survey questions can be disseminated to Internet users and TV viewers, and the answers are processed at a central location. In exchange for his answers, the responder receives free access to the Internet or cable TV for a predetermined amount of time.

The survey questions are typically transmitted on a TV channel or via the internet. The response is by the mouse or keyboard of a computer terminal.

There are also a number of very special applications for computer/TV based survey technology. For example, U.S. Patent Application No. US20050144633 to Babyan entitled “World-wide non-time based poll method for determining best image of a child” describes a favorable child image determination method e.g. for playing game at home, involves displaying publicly accepted images of children and accepting votes from general public on images. The application describes a world-wide and non-time based method of comparing images of children and determining the best child image, in which a child image of any person may be used. Instead of placing a time based restriction on images to be compared, images from any date from the inception of photography until the present may be used. No limitation on present age of the individual pictured, age of the photograph or the like is used. The method may be embodied as a search, or as a contest or game. It may be embodied as a method of playing a game at home, a method of playing a television game, as an Internet method, as an advertising/business method, and as combinations thereof.

U.S. Patent Application No. US20040216041 to Ajizadeh, entitled “System and methods in interactive television and radio ratings through the internet and the telephone” describes a TV/radio rating method that involves entering TV viewing and radio listening capabilities into the inventor's published website by individuals, to perform rating. Essentially, an interactive published website designed so the general television viewing public will have an opportunity to interactively submit their input on what television show they are or have just finished watching. People can log into the website and register as members. Once they are members, they can log in with us and mark the correct icons referenced to the television show they are or have just finished watching, pressing the send button will send us their input. Participants have to log onto the Internet to post their feedback. Many viewers will not make the required effort, and the results obtained will inevitably be skewed.

U.S. Pat. No. 6,616,458 to Walker et al. entitled “Method And Apparatus For Administering A Survey” describes a Validity test for interactive television based survey that comprises test questions indicating if a respondent is meaningfully responding. Specifically, in accordance with the invention, a controller such as an online service provider computer or an ISP computer receives a survey including survey questions from a client desiring to have a survey conducted. The controller creates respondent questions based on the survey questions. The controller also selects one or more respondents from a list of possible respondents, such as a list of customer accounts. The respondent questions are transmitted to the selected respondents. Responses corresponding to the respondent questions are received. The controller applies an inconsistency test to the responses to generate an inconsistency test result. The inconsistency test determines if the responses originate from computers or humans not paying attention to the questions. Based on the inconsistency test result, a fraud signal may be generated. The fraud signal may result in several actions, such as the controller ignoring the responses received from the corresponding respondent, reducing or eliminating payment to the respondent, transmitting a message of reprimand to the respondent, and/or barring the respondent from future participation in surveys. The technology described relates to an Internet type survey, using dedicated survey tools and database.

U.S. Pat. No. 6,513,014 to Walker et al. describes a “Method and Apparatus for Administering a Survey via a Television Transmission Network”. The thrust of the patent relates to a validity test for interactive television based surveys that comprises test questions indicating if respondent is meaningfully responding”. Essentially, a controller such as a cable television company receives a survey including survey questions from a client desiring to have a survey conducted. The controller creates respondent questions based on the survey questions. The controller also selects one or more respondents from a group of respondents requesting to participate in a survey. The respondent questions are transmitted to the selected respondents via a television transmission network, e.g., a cable television transmission network. Responses corresponding to the respondent questions are received. The controller applies an inconsistency test to the responses to generate an inconsistency test result. The inconsistency test determines if the responses originate from computers or humans not paying attention to the questions. Based on the inconsistency test result, a fraud signal may be generated. The fraud signal may result in several actions, such as the controller ignoring the responses received from the corresponding respondent, reducing or eliminating payment to the respondent, transmitting a message of reprimand to the respondent, and/or barring the respondent from future participation in surveys.

Taiwan Patent Number TW0546592 entitled “Electronic Device Integrating Multiple Functions And Services” relates to an electronic device that integrates multiple functions and services to connect with a telephone line. In a preferred embodiment, a TV is used as the interface to display data. The electronic device at least provides the functions of caller identification, transmitting/receiving short messages and email identification, and further realizes the electronic poll survey and electronic advertisement service. By communicating with smart home electronic products, security system and portable devices, the electronic device provides a more versatile service. The electronic device can be integrated into a TV, so that the TV that is very popular at home can provide a more versatile functions and services in addition to entertainment.

Although there is no English language equivalent available, clearly dedicated consumer hardware is required, making implementation difficult and expensive, particularly for a large participating audience

Bulgarian Patent Number BG 0104482 entitled “Device For Public Poll Investigation” relates to a device studying the views of TV viewers, and is based on a device for the collection of information about the viewers' interest in TV programmes, with a TV converter with indication of the screen of the TV set, enabling connection to a central computer, collecting and processing the information by a modem on a telephone line or on the return channel of a cable television network. Once again, dedicated hardware appears to be described.

European Patent Application Number EP0694244 (PCT Publication Number WO9531068A1) entitled “Interactive Television System” describes an interactive television system that includes a decoder connected to a TV receiver which reads messages transmitted with video signals which are also displayed on TV screen and an interface allowing direct access to telephone line. Specifically, an interactive television system enabling the user to interact with the system and to participate actively in television programmes such as quiz, commercials, opinion polls etc., is described. Each subscriber station includes a television receiver, a decoder connected to the television receiver and suitable to read the messages (TTX) transmitted together with the video signal, and to display them in impression on the television screen, an infrared remote control with at least four “navigation” keys and a confirmation key, and a device for direct and automatic access to the telephone line (LT) radio-frequency connected to said decoder. Once again, the interaction is via the remote of a special TV receiver that has a modem for transmission of viewer input over a phone line. Such a system requires dedicated hardware.

PCT Publication Number WO9417609A1 titled “Television Viewer Monitoring System” describes an audience attention monitor for TV or radio transmission that transmits data on the channel and time from store via cellular telephone module. A system for monitoring and collecting data on the viewing habits of television viewers or radio listeners is described. The system enables operators of networks or television stations, programmers and advertisers to determine the numbers of viewers watching particular programs. Hardware includes portable personal data collection devices that comprise a detector for providing a station identifier identifying the particular broadcast signal being received by the receiver, a clock for providing a signal representing time, a memory for storing data, a cellular telephone module for communicating with a central location, a control for the cellular telephone module, and a microprocessor. The microprocessor stores in the memory data comprising the station identification, and the time at the beginning and end of receiving signals from that station. The control is arranged to control operation of the cellular telephone module to transmit the stored data to the central location. The control may respond firstly to a time signal representing a preselected time for operating the cellular telephone module to call the central location and secondly to communication being established with the central location before transmitting the data. Additionally, or alternatively, the control may respond to a call initiated from the central location to transmit the data. The data collection device may include a detector for detecting a channel selection signal from a television remote control to change the station identifier stored in memory and/or a sound detector for detecting a pseudo-random sequence encoded into the broadcast audio signal and decoding it to drive the station identifier and/or other information such as time of day, polling questions, and so on. Manual inputs, for example pushbuttons, may be provided for confirming that the user is actually in attendance. Once again, such a system requires dedicated hardware.

U.S. Pat. No. 4,989,233 titled “Systems for capturing telephonic mass responses” relates to capturing telephonic mass responses using electronically captured telephone numbers to call on a multitude of sets at one time and prompt subscribers. Here recipients of a promotion broadcast over an essentially one-way mass medium are prompted to respond thereto through their telephone sets having different subscriber telephone numbers, and the task of handling the resulting mass response is divided into a call receiving phase and a subsequent response completing phase. Such call receiving phase is shortened relative to the response completing phase by automatically receiving calls of recipients using their telephone sets to respond to the broadcast promotion, electronically capturing the subscriber telephone numbers of the telephone sets through which these calls are made, and automatically confirming to substantially all callers while on line during these calls that their calls have been received. The response completing phase is subsequently carried out by using the electronically captured subscriber telephone numbers to call on multitudes of the telephone sets at a time, electronically prompting all persons who answer the calls on these multitudes of telephone sets to complete their responses to the broadcast promotion through their telephone sets while on line, and automatically receiving the completed responses while on line with these persons through their telephone sets. In one system embodiment, a plurality of subsystems are geographically distributed over a wide area, and each subsystem of the plurality carries out both the call receiving phase and the response completing phase for calls received by a particular subsystem. Each subsystem stores information generated by and received through such subsystem, and the stored information is polled from a centralized location.

U.S. Pat. No. 6,678,360 entitled “Telephonic-Interface Statistical Analysis System” relates to an online data handling method for a telephone facility, involves storing caller telephone number data in memory such that data is accessible by selected customer, and updating data relating to caller in memory.

Essentially a system interfaces with a multiplicity of individual terminals T1-Tn of a telephone network facility, at the terminals callers are prompted by voice-generated instructions to provide digital data that is identified for positive association with a caller and is stored for processing. The caller's identification data is confirmed using various techniques and callers may be ranked and accounted for on the basis of entitlement; sequence or demographics. Callers are assigned random designations that are stored along with statistical and identification data. A break-off control circuit may terminate the computer interface aborting to a terminal for direct communication with an operator. Real-time operation processing is an alternative to stored data. The accumulation of stored data (statistical, calling order sequence, etc.) is variously processed and correlated as with developed or established data to isolate a select group or subset of callers who can be readily identified and reliably confirmed. Different program formats variously control the processing of statistical data as for auction sales, contests, lotteries, polls, commercials and so on.

Applications of this technology are audible only, in that polling and commercials are transmitted over the telephone itself. Such applications only use the sense of hearing, and dialed up participants have to listen to lengthy, wordy explanations to make polled data useful.

European Patent No. EP0998107 entitled “Interactive Call Handling” relates to a telephonic-interface statistical analysis system having a call data analyser for modifying data from several callers under control of terminal digital signals. Essentially, calls made from telephone terminals T1-Tn via a telephone network C are handled concurrently within a receiving station D by processing systems P1-Pn that by means of automated voice messages prompt the callers through an interactive sequence to operate their telephone push-buttons to signal digital data to the station D. Digital data received from each caller and derived otherwise from his call, is stored, and, according to the processor operating format selected, gives specific identification of the caller, health data, and call sequence-order or time, together with processor-derived data which the caller is prompted to signal back to the processor for confirmatory purposes. Selection of format, and with it the particular processor PR1-PRn used, depends upon the number called as signalled to the receiving station by a dialed-number identification system (DNIS) of the network. The format may alternatively relate to telephone-order purchasing, participation in a lottery, or participation in a TV auction, gameshow, or opinion-poll. The caller is first checked for qualification to participate before processing of the gathered data is carried out. Calls may be transferred to be progressed with assistance from an operator's terminal IT when qualification checks are not satisfied.

European Patent No. EP0694244 entitled “Interactive Television System” relates to an interactive television system that includes decoder connected to a TV receiver which reads messages transmitted with video signals which are also displayed on TV screen and the interface allows direct access to telephone line.

Chinese Patent Application Number CN1249622A relates to Vote-type television broadcast system that is composed of a microcomputer, video/audio generator, TV broadcast device, public communication network, public TV network, telephone statistic subsystem, network statistic subsystem and IP transmission subsystem. Said video/audio generator is connected to TV broadcast device, which is connected via public communication and TV networks to telephone statistic subsystem. The IP transmission subsystem is used to connect video/audio generator, telephone statistic subsystem and network statistic subsystem together. It can be used for vote-type broadcast on demand, public opinion poll and enterprise investigation.

Russian Patent Application RU2127143C1 entitled “Method for Interactive Game or Sociological Interaction” relates to entertainment games, polls using TV and radio communication. The method involves broadcasting numbers of telephones to participants in the game or sociological interaction, in addition, during at least one TV or radio program. The method involves broadcasting information with a group of choices which are designed as menu or request stating at least one telephone number for receiving information from TV viewers or radio listeners. Each telephone call is recorded in order to identify caller. Received information is analyzed using at least one evaluation criterion. Broadcasting programs are corrected using results of analysis. In addition, received information is analyzed using chosen at least one selection criterion and selection of at least one TV viewer or radio listener as winner or awarded person. In addition broadcasting programs are corrected using results of analysis. TV viewers or radio listeners transmit information using communication network which has central node and telephone processing nodes, which are distributed and processes information which is received from public telephone network. Results of processing are sent from telephone processing nodes through telephone transmission line to central node. In addition mass media, for example, TV or radio broadcasting or press is used for transmission of group of choices together with telephone number for receiving information from TV viewers or radio listeners. Each telephone call is recorded for possibility of subsequent identification of caller using calling telephone number as registration number. In addition in order to prevent choice of at least two contradicting information options by same TV viewer or radio listener, location in computer memory corresponding to registration number of this TV viewer or radio listener is marked, so that information choices with same registration number are checked against marking of this choice. In case if choice corresponds to given criteria, value in corresponding location in computer memory is increased or decreased.

Japanese Patent Application Number JP 11275607A2, entitled “Survey System By Television Audience Rating” addresses the issue of providing an audience rating survey system with a simple constitution, which is easily installed and can construct a system for automatically collecting program rating information, without requiring much time or cost. The solution proposed is based on the presumption that an automatic meter reading system which automatically reads a gas meter, a water meter, an electrical meter, etc., have already been set up in the house of a monitor. A modem is connected to a telephone set and a meter, and can be connected to a network as necessary. The audience rating surveying device is connected to a modem, and when a program rating information transmitting request is made from a central device for audience rating survey, data are transmitted to the device via the modem and a network by connecting the modem to the survey device side. The survey device receives infrared signals when the remote controller of a television receiver is operated, analyzes operated states of channels, and stores the analyzed results as program rating information. When the survey device is requested from the central device, the device transmits the program rating information. Apparently, the system proposed requires dedicated hardware, with the inherent disadvantages discussed above.

Japanese Patent Application Number JP04205368A2 entitled “Real Time On-Line Survey System” addresses the issue of answering a questionnaire in real time by reading questionnaire software designated from plural questionnaire software stored in a host computer in a holding terminal system by using a telephone line, and answering to the questionnaire.

The questionnaire software stored once in memory in a terminal main body is further read in the terminal main body via boot ROE, and is analyzed with an operation signal SB inputted to the terminal main body via a control pad by a user, and a monitor control signal is generated, and is sent out to a television monitor thereby, the control of picture of the television monitor 4 is performed. The user reads audio visual information obtained from the television monitor 4 as the content of the questionnaire, and inputs a questionnaire input signal to the terminal main body 1 by operating the control pad 3, and an answer to the questionnaire is issued. In such a case, access to a host computer 8 is performed via a modem 6 and a telephone line network 7. In such a way, the questionnaire can be easily executed. Once again, it would appear that the system proposed requires dedicated hardware, with the inherent disadvantages discussed above.

U.S. Pat. No. 4,905,080 entitled “Apparatus for Collecting Television Channel Data and Market Research Data” includes TV channel data collecting apparatus for market research, and has the detected channel and identification data transmitted to data processor via commercial power distribution line. Essentially, a data collecting apparatus is used in a survey system in which research data such as television audience ratings and market research data is collected by a data collecting device provided in each of a plurality of panelists' homes, the collected research data is sent to a data center through telephone links, and, at the data center, the data is processed with the aid of a large scale computer to calculate desired research data. The data collecting apparatus includes a channel detector for detecting a television channel being viewed, a market research data entry device, a personal data entry device, and a data processing device for storing and processing the entered data. The detected channel data and the entered personal data are transferred to the data processing device via domestic power supply lines. The market research data is efficiently entered with the aid of a bar-code reader and a keyboard in a sequence-non-ordered manner. The personal data is entered with an entry device using infrared light. The personal data entry device may have picture-like illustration images of respective panelists so that they need not remember personal identification numbers. Notably, the data entry is via a keyboard or bar-code reader, i.e. special consumer hardware is required by participants.

U.S. Pat. No. 4,603,232 and European Patent Number EP0245569A1 entitled “Rapid Market Survey Collection and Dissemination Method” relates to a method for independently centrally electronically accumulating market survey data from different content rapidly disseminated market multiple inquiry market surveys from a plurality of panelist stations located at diverse locations. Variable market survey questionnaires to diverse located panelists may be remotely rapidly disseminated from a centrally located host computer to the panelist stations over a common communications link for individual visual display at the panelist stations, such as on a CRT or television set or alphanumeric display, with the displayed questionnaires resulting from a downstream loaded set of control instructions stored in a local survey program RAM whose content may be remotely varied from the head end or host computer. The individualized responses provided by the panelists are locally processed, temporarily stored in a local survey data RAM and subsequently transmitted back to the host computer via a telephone type link where they are accumulatively processed in a rapid fashion. Multiple different surveys can be downstream loaded to individual panelists, or to a subgroup of panelists, or to all panelists, and follow up surveys and/or tailored surveys can also be rapidly conducted, all under the control of the host computer at the head end providing a rapid and flexible survey collection and dissemination method.

U.S. Pat. No. 4,584,602 entitled “Polling System and Method Using Non-dedicated Telephone Lines” relates to a data acquisition method for collection TV audience rating data that permits data to be collected immediately from wide areas. Specifically, an audience data rating collecting system and method which are capable of collecting television audience rating data automatically within a short period of time are discussed. A broadcasting station transmits over the air a marker signal. The marker signal is received by terminal units associated with selected subscribers' television receivers. Upon reception of the market signal, and after waiting a period of time necessary for other terminal units within the system to transmit their data back to the station, each terminal unit automatically dials a predetermined telephone number at the broadcasting station. Once the broadcasting station has had time to automatically answer, data from that terminal unit representative of the channel then being viewed is transmitted over the telephone circuit to the broadcasting station. After all terminal units have called in, the results are tabulated.

PCT Publication Number WO8401072A1 entitled “Automatic Audience Survey System” describes a telephone based audience survey system that is accessed by a single telephone number. The survey system permits surveys to be conducted automatically instead of manually. The equipment, which can be used at a radio or television station and controlled therein, answers incoming calls with an analog voice signal and asks for an oral response in regard to the question of interest. It provides and displays data as to the answers or votes made by the individuals in the audience. The automatic audience survey system includes a microprocessor based automatic telephone polling station connected to a rotary type telephone exchange via a plurality of telephone line interface control subsystems.

Japanese Patent Application Number JP 59086343A2 entitled “Data Gathering Device” serves to gather receiving information of a wide range of district at low cost by counting up the TV receiving channel information stored by a marker signal automatically via a telephone line. When a survey command is outputted from a broadcast station, a marker signal is superimposed on a TV broadcast signal, a receiver of each counter is connected by switching from a telephone set to a decoder, and disuse of the telephone set is displayed by lighting a display device. On the other hand, receiving channel information of a TV receiver is stored at the detection of the marker signal and after the elapse of time by a timer, the stored data is coded and transmitted automatically. After a control circuit of a broadcast station applies the data by the receiver to the decoder, the receiver is opened from a line. Further, the decoded output is applied to a counter.

Japanese Patent Application Number JP 59086341A2 entitled “Data Gathering System” relates to a technology that serves to execute instantly the gathering of data from an area of wide range by storing the data at detection of a marker signal broadcast to a device of each home and transmitting the stored data after a prescribed time, in an audience rate survey. A broadcast station transmits a video signal via a mixer and a transmitter. An H synchronizing signal in the video signal is counted, and a control circuit applies a prescribed marker signal to the mixer in synchronizing with the counted output. Each home branches a receiving signal, which is applied to a TV receiver and a detector provided, corresponding to a telephone set. A tuner of the detector detects a marker signal by the counted value coincident with the value of the counter of the broadcast station and the broadcast information during receiving is stored by the detected output. The stored information is read out after a prescribed time by a timer and transmitted to a gathering terminal of the broadcast station via an encoder, an automatic telephone transmitter, and a telephone line.

WIPO Publication Number WO05050969 entitled “Mass Viewer Audience Circuit Based Real Time Participation In Interactive Applications Displayed Live On Display Screens”, incorporated herein by reference, is an earlier application of the present inventor. It is directed toward mass viewer audience circuit based real time participation in live TV shows, and other interactive applications displayed on electronic billboards, so-called vidiwalls, and the like. It utilizes a mass viewer audience response detection gateway for establishing inbound half duplex line connections with callers' telephones on receiving circuit based telephone calls therefrom for determining callers' DTMF key depressions corresponding to their real time responses to an interactive application, and transmitting real time information regarding the callers' responses for providing real time feedback to the mass viewer audience watching the interactive application, and particularly the callers continuously holding their telephones like a hand held TV remote control and depressing on the DTMF keys on their telephones to input their responses to actively participate therein without interrupting their participation to listen to pre-recorded playback messages regarding DTMF key assignments. This publication describes a technology that allows a mass viewer audience, i.e. a GROUP, to participate in a TV show in real time. It does not relate to conferences and the like.

PCT Application Number PCT/IL2006/000262 to the present applicants, incorporated herein by reference, describes a method and apparatus for conducting real time dialogues with mass viewer audiences during live programmes. Specifically, a system for conducting real time dialogues with an audience comprising a plurality of remote viewers of a broadcast programme is described. The system comprises: (a) a Real Time Dialog Machine having input ports for enabling substantially simultaneous data input from each of a plurality of viewers in data communication therewith over at least one data network; (b) a Dialogue Management Console coupled to the Real Time Dialog Machine via a data link, said Dialog Management Console for allowing management of said dialogues by program production personnel; (c) a database of interactive sessions accessible by the dialogue management console and in data communication with the Real Time Dialog Machine via a participation processor for processing aggregated data from the Real Time Dialog Machine, and (d) displaying means for adding derived data and/or visual cues to program for transmission to displays viewable by the viewers.

PCT Application Number PCT/IL2006/000337 to the present applicants, incorporated herein by reference, describes a system for allowing presentation of a Group Response Event (GRE) to a group of participants: the GRE comprising at least a first question and a range of possible answers to the at least a first question; the system comprising a hosting website accessible by at least one web-browser connected to a display, the web-browser and display being viewable by at least a first group of participants at a first location, such that members of said at least a first group of participants can individually respond to said at least a first question by inputting one of said range of possible answers via personal telecommunication devices.

Despite the extensive prior art, there is still a need for a system that can be used to monitor ratings of a TV program, and viewer satisfaction therewith, or to conduct market research with TV viewing audiences that overcomes the disadvantages of the prior art systems. The present invention addresses this need.

### SUMMARY OF THE INVENTION

It is an aim of the invention to provide an apparatus and associated method for conducting surveys of large sample populations wherewith the participants do not require dedicated equipment.

In a first aspect, a Consumer Research Survey Management Apparatus is provided. The Consumer Research Survey Management Apparatus comprises: A Survey Management Console interfaced with a Survey Participant Response Machine through which results of survey participation are collected and processed.

Typically, the Survey Management Console interfaces with a Results Processor and a Survey Participant Registry.

The Results Processor includes a Results Repository and a Rewards Repository.

Typically, the Survey Participant Registry comprises a list of people who have consented to participate in surveys and have provided validated demographic information.

Preferred embodiments of the Consumer Research Survey Management Apparatus further comprise a Broadcast Graphic Overlay Interface for generating and modifying graphic overlays that are addable to broadcast TV signals to provide participation cues and information to viewers, particularly survey participants.

Typically, the Survey Participant Response Machine is hosted on at least one computer server capable of handling extensive communication bandwidth and processing requirements.

Typically, the Survey Participant Response Machine comprises both standard IP interfaces for connecting to Internet and to private IP networks and specialized interfaces for connecting to telephony and digital cable networks.

Preferably, the Survey Management Console has a modular construction and includes modules selected from the list of: an Authoring Module; a Scheduling Module; a Survey Participant Incentive Module; a Target Population Control Module; an Integrity & Validation Control Module and a Results Analysis Module.

Preferably, the Survey Management Console comprises an Authoring Module for providing survey organizers with an authoring environment for authoring surveys according to their requirements.

Preferably, the Survey Management Console comprises a Target Population Control Module that allows research surveys to be addressed to populations selected from the list of ad-hoc, predetermined and controlled target populations.

Preferably, the Survey Management Console comprises a Scheduling Module that enables the planning, monitoring and controlling of the delivery of consumer research surveys. Preferably, the Scheduling Module enables consumer research providers to establish a broadcast schedule in which consumer research surveys can be listed and repeated a number of repetitions. Optionally the Scheduling Module schedules transmission of surveys within an existing, scheduled broadcast. Alternatively, the Scheduling Module schedules transmission of surveys on a dedicated research channel.

Preferably the Consumer Research Survey Management Apparatus facilitates the holding of surveys and comprises functionality for authoring surveys, managing target populations, scheduling surveys, managing survey participant incentives, and for integrity and validation control and result analysis.

Preferably the Consumer Research Survey Management Apparatus includes automatic tools for aggregating the results from multiple broadcasts while maintaining population validity in terms of parameters selected from the list of demographics, quantity, quality and participant validity in terms of truthfulness.

Typically the Survey Participant Incentive Management Module enables incentives to be integrated into the Consumer Market Survey Management Apparatus. The incentives may be selected from the list of (i) rewards offered to participants based on qualitative and quantitative indicators of participation; (ii) improved rewards offered to truthful participants who answer all questions; (iii) rewards raffled between all participants; (iv) rewards raffled between participants from specific participation groups; (v) rewards adjusted and modified for registered participants based on their overall participation over a period of time.

Optionally, reports are generated and relayed to an actual payment distribution system for making payments. Such reports are generated according to parameters selected from the list of surveys, participants, participant groups and time periods. Optionally, details of rewards are accumulated in a database for use in generating total reports. Such total reports are selected from the list of total reward per participant, total reward per participant group, total reward per survey by researcher and total reward per customer.

Preferably a Survey Integrity & Validation Module is provided for providing real-time monitoring and control tools for ensuring the integrity and validity of surveys.

Preferably, the Consumer Research Survey Management Apparatus includes tools selected from the list of real-time indicators of truthfulness and completion for both participants and participant groups; real-time statistics such as number of participants in current screening; number of accumulated participants, and participation demographic statistics compared to research requirements. Such tools may include participant management tools for disconnecting untruthful participants from the Consumer Research Survey Management Apparatus and for identifying and filtering out repeat participants across numerous screenings.

Optionally and preferably, real-time demographic information on accumulated participants is usable to adjust the demographic requirements for future runs.

Optionally and preferably, Research Management Tools are provided that enable the research survey delivery to be altered in real-time, either through operator intervention or automatically, in response to participation indicators and results.

Filtering and qualifying of answers to be added to the result-set may include aggregated indicator information selected from the list of individual survey participants and survey participant groups, for example. Preferably, filters and result-sets are savable for reuse.

Optionally and preferably, analysis tools are provided for creating and testing indicators for specific panelists.

Optionally and preferably, analysis tools are provided for creating and testing indicators for entire populations.

Optionally, the Consumer Research Survey Management Apparatus is usable for conducting surveys selected from the list of quantitative surveys wherein participants are required to respond to an extensive questionnaire, and rating surveys, where targeted, queried consumers provide information regarding their actual television viewing at time of querying.

Typically, queries are displayed on a TV screen during viewing of a broadcast program and responses are provided by responding viewers using their mobile phones.

Optionally and preferably, the Consumer Research Survey Management Apparatus is usable for transmitting surveys, said surveys that are adjustable during their transmission.

In a second aspect, the present invention is directed to providing a method for holding surveys using the Consumer Research Survey Management Apparatus described hereinabove, the method comprising the steps of authoring a survey (Step I); determining whether the target population is ad-hoc or a set target (Step II); setting the survey schedule (Step III); activating the survey (Step IV); monitoring the survey in terms of its validity and integrity (Step V) monitoring participation levels (Step VI); optionally awarding incentives to survey participants (step VII); ensuring that the survey matches the research requirements in terms of population quotas (Step VIII) ensuring that the demographic profile of the survey participants matches the research requirements (Step IX); repeating at least part of the survey if necessary (Step X) and analyzing results (Step XI).

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic block diagram a Consumer Research Survey Management Apparatus for facilitating the holding of surveys;

FIG. 2 is a schematic illustration of an exemplary Survey Management Console screen;

FIG. 3 illustrates a TV screen displaying a callback telephone number and four different types of footwear;

FIG. 4 shows a TV screen displaying a callback telephone number and four items to be ranked in order of importance by survey participants;

FIG. 5 is a screen capture of a pilot TV show together with a callback telephone number for viewers to call;

FIG. 6 shows a playback of the pilot TV show together with a chart depicting the aggregated satisfaction of the viewing audience synchronized therewith;

FIG. 7 shows an exemplary Survey Management Console screen with a pane showing the percentage of survey participants compared to the intended number of survey participants for a particular question, and

FIG. 8 is a flowchart showing the operation of the Consumer Research Survey Management Apparatus for holding surveys.

### DESCRIPTION OF THE PREFERRED EMBODIMENTS

The present invention is directed to providing a system and method for monitor ratings of a TV program, and viewer satisfaction therewith, and/or for conducting market research. It is a feature of the system and methods provided that, regular consumer hardware is used. This minimizes the burden on pollsters and on audiences, in that it is not required to distribute dedicated hardware to polled audience. The system enables the addressing of complex questions to target audiences, and is able to cope with large and thus representative population samples.

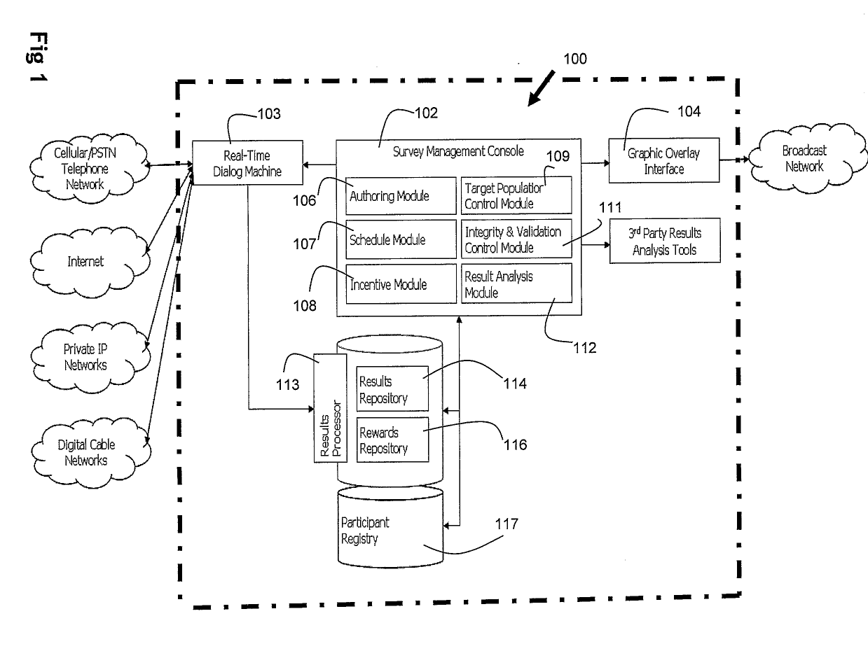

With reference now to FIG. 1, a schematic block diagram of the functional units of one embodiment of a Consumer Research Survey Management Apparatus 100 for facilitating the holding of surveys is shown. Consumer Research Survey Management Apparatus 100 typically includes functionality for authoring surveys, managing target populations, scheduling surveys, managing survey participant incentives, and for integrity and validation control and result analysis, for example.

The Consumer Research Survey Management Apparatus 100 includes a Survey Management Console 102 that interfaces with a Survey Participant Response Machine 103 through which results of survey participation are collected and processed and a Broadcast Graphic Overlay Interface 104 which generates and modifies graphic overlays added to broadcast signals to provide participation cues and information to viewers in general and survey participants in particular.

The Survey Management Console 102 interfaces with a Results Processor 113 and a Survey Participant Registry 117. The Results Processor 113 includes a Results Repository 114 and a Rewards Repository 116. Survey Participant Registry 117 is typically a list of people who have consented to participate in surveys and have provided validated demographic information.

The Survey Participant Response Machine 103 is typically hosted on one or more computer servers capable of handling extensive communication bandwidth and processing requirements. Survey Participant Response Machine 103 contains both standard IP interfaces for connecting to Internet and to private IP networks and specialized interfaces for connecting to telephony and digital cable networks.

The Graphic Overlay Interface 104 may be implemented by a prior art graphic rendering solution, such as any one of a number of graphic rendering solutions commercially available from companies such as VizRT (www.vizrt.com) and Orad (www.orad.co.il). Graphic rendering solution is used to relay graphical data to viewers across broadcast networks.

The Survey Management Console 102 may be a specific or a general purpose computer and typically includes an Authoring Module 106, a Scheduling Module 107, a Survey Participant Incentive Module 108, a Target Population Control Module 109, an Integrity and Validation Control Module 111 and a Results Analysis Module 112. These modules are now described in more detail:

The Authoring Module 106 provides survey organizers with an authoring environment for authoring surveys according to their requirements. The Authoring Module is based on co-pending Israel Patent Application No. 167,126 filed 28 Feb. 2005 and entitled Method and Apparatus for Conducting Realtime Dialogues with Mass Viewer Audiences During Live Broadcasts. Dependent questions can be designated and applied both during the research itself and/or during analysis. Questions and answers can be categorized and flagged for later use for indicator processing. Questions and answers coding methods can be integrated into the authoring process for compatibility with conventional data-handling techniques and tools.

The Target Population Control Module 107 allows research surveys to be addressed to both ad-hoc and to predetermined or controlled target populations. An ad-hoc target population is inherently available by addressing all audiences.

The Scheduling Module 108 enables the planning, monitoring and controlling the delivery of consumer research surveys. Survey Scheduling enables consumer research providers to establish a broadcast schedule in which consumer research surveys can be listed and repeated numerous times. The number of repetitions may be predetermined or based on the participation objectives for a survey. Surveys may be transmitted within an existing, scheduled broadcast, or, may be transmitted on a dedicated research channel.

Research topics may be allocated to “prime-time” slots or may be transmitted at other times suitable for reaching a desired target population. Research popularity can be based on both predetermined parameters and on actual rating by the level of participation. Popularity indicators can be used, manually or automatically, to update survey scheduling.

Automatic tools are provided to aggregate the results from multiple broadcasts while maintaining both population validity in terms of demographics, quantity, quality, etc., and participant validity in terms of truthfulness, perhaps by filtering out repeated attempts to answer for controlled population surveys, for example.

The Survey Participant Incentive Management Module 109 enables incentives to be integrated into the Consumer Market Survey Management Apparatus 100. Such incentives may include rewards offered to participants based on the qualitative and quantitative indicators of participation, with truthful participants who answered all questions being offered higher rewards than untruthful participants, for example. Additionally or alternatively, rewards can be raffled between all participants, or between participants from specific participation groups. Additionally or alternatively, rewards can be adjusted and modified for registered participants based on their overall participation over a period of time. For example, a bonus reward could be offered for participating in, say, ten surveys in one time period, or the reward per survey can be increased as a function of the number of periodic participations, etc.

Typically, reports are generated per survey/participant/participant group/period and relayed to an actual payment distribution system for making payments. Additionally, details of rewards may be accumulated in a database that can be used to generate reports such as total reward per participant/participant group, total reward per survey by researched/customer, etc.

The Survey Integrity & Validation Module 111 provides real-time monitoring and control tools for ensuring the integrity and validity of surveys. These may include real-time indicators for participant/participants group of truthfulness and completion, real-time statistics such as number of participants in current screening, number of accumulated participants, participation demographic statistics compared to research requirements, etc. are presented to the operator at any given time.

Participants Management Tools may be provided so that untruthful participants can be disconnected from the Consumer Research Survey Management Apparatus and repeat participants across numerous screenings can be identified and filtered out. Real-time demographic information on accumulated participants can be used to adjust the demographic requirements for future runs. For example, if a survey requires a population of participants between the ages of 18 and 35 and the initial screenings of a survey reached mostly participants between ages 18 and 25, future runs can be configured to accept a higher percentage of participants (or only participants) in the age group 25 to 35.

Research Management Tools are provided that enable the research survey delivery to be altered in real-time, either through operator intervention or automatically, in response to participation indicators and results. Questions that were unanswered by many participants can be re-delivered at the end of a screening to offer survey participants a second chance to answer, perhaps as a prerequisite to qualify for a reward. Consumer research screening schedules can be dynamically altered based on set objectives, research requirements and participation results.

Indicators for registered survey participants may be accumulated and used to generate an overall “Survey Participant Quality Indicator” which can be used for filtering survey participants. In this manner, “High-profile” researches perhaps those offering significant rewards for participation therein, can be open to registered participants with high quality indicators only.

Aggregated indicator information, both for each survey participant and for survey participant groups, can be used for filtering and qualifying answers to be added to the result-set. Filters and result-sets can typically be saved for reuse.

Analysis tools may be provided for creating and testing indicators for both entire populations and for specific panelists. Such indicators can be used for testing issues such as personal integrity & truthfulness, group cohesion and the like. Indicators can be used for taking action during the survey itself, such as to disconnect a panelist whose truthfulness indicator is in the bottom percentile of the group, for example. Indicators can also be used during analysis as an add-on to the raw results or for filtering or affecting statistic calculations of results.

Third Party Analysis Tools may be used for statistical analysis of research results. The Results sets can be exported from the Survey Management Apparatus in a variety of standard formats.

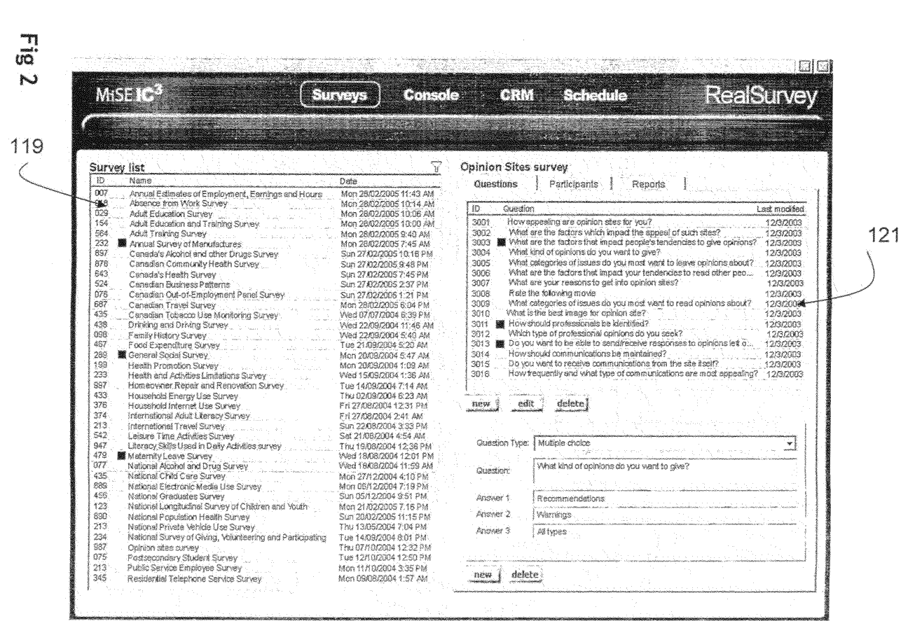

With reference now to FIG. 2, an exemplary Survey Management Console screen 118 is shown. Survey Management Console screen 118 includes a Survey List pane 119 that lists surveys, and a Question pane 121 where the questions in a consumer research survey directed toward Opinion sites is listed.

The Consumer Research Survey Management Apparatus 100 enables various types of surveys, such as quantitative surveys wherein participants may be required to respond to an extensive questionnaire, and rating surveys, where targeted, queried consumers merely provide information regarding their actual television viewing at the time of querying.

Quantitative surveys are based on questions and answers, and may be hosted in a TV-show format with a live host, for example. Questions are presented to survey participants in a pre-arranged sequence. Questions types typically include multiple choice questions where participants have the option of selecting one or numerous answers from a displayed list of allowed responses, and/or sequencing questions where numerous items are required to be sorted in accordance to set criteria in the questions, such as preferences, for example. Generally, one question is presented to participants, and after being answered, the next question is presented, and so on until the questions are exhausted.

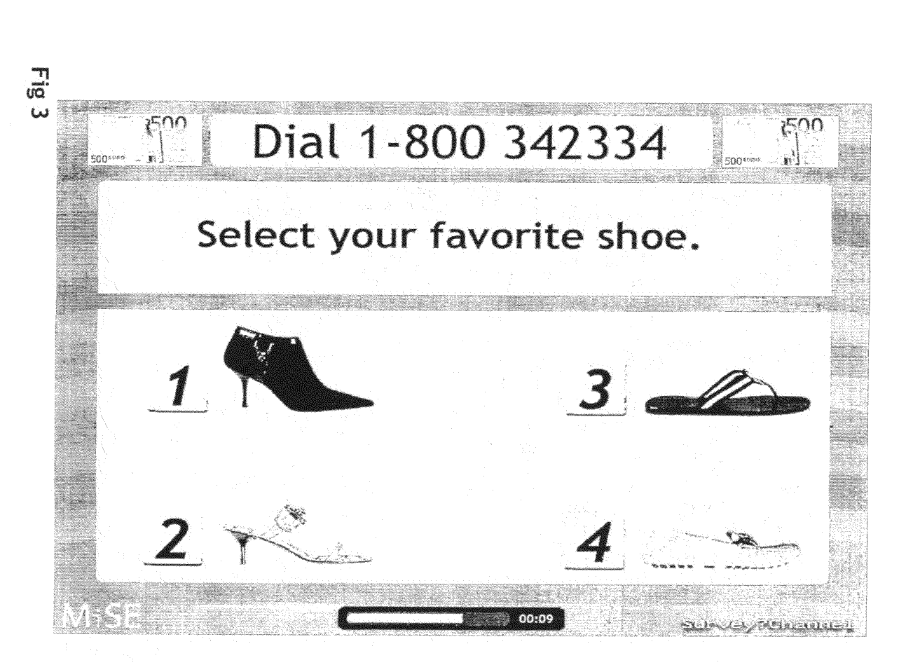

By way of example, FIG. 3 shows a TV screen displaying a callback telephone number and four different types of footwear regarding which survey participants are requested to respond by selecting their preferred type of footwear, ranking the footwear according to their reference, and the like.

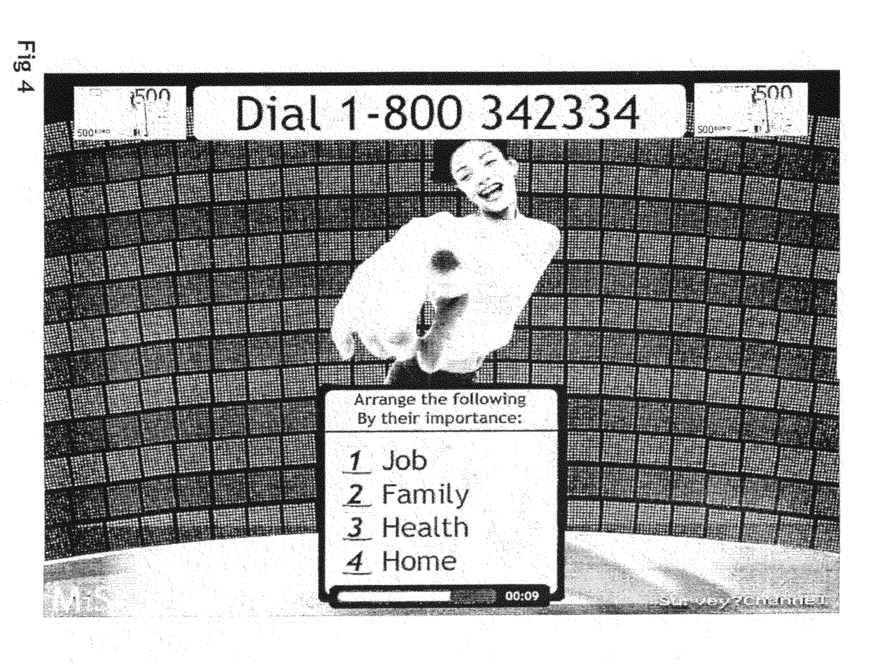

FIG. 4 shows a TV screen displaying a callback telephone number and four items to be ranked in order of importance by survey participants.

Questions may be complemented with visual content such as graphic and video elements, wherewith survey content related to the questions is portrayed thereby allowing the survey to be customized. Each question may be allocated a separate time interval for response.

It is a particular feature of the Consumer Research Survey Management Apparatus 100 that transmitted surveys may be adjusted on the fly or in response to predetermined criteria. For example, the sequence and make-up of the questions may be changed in response to real-time results. By way of example, if 80% of survey participants select Answer 3 to a multiple choice question 32, then the transmitted survey could be adapted to skip questions 33 to 40, now redundant, and have question 41 transmitted.

Continuous rating surveys are based on collecting and aggregating continuous audience feedback regarding a continuous broadcast in real-time. Typically a large target population is surveyed. Continuous rating surveys are ideal for testing Pilot TV-shows, commercials and the like, exposing the program to a desired target audience without requiring gathering a large audience to a TV studio or the like.

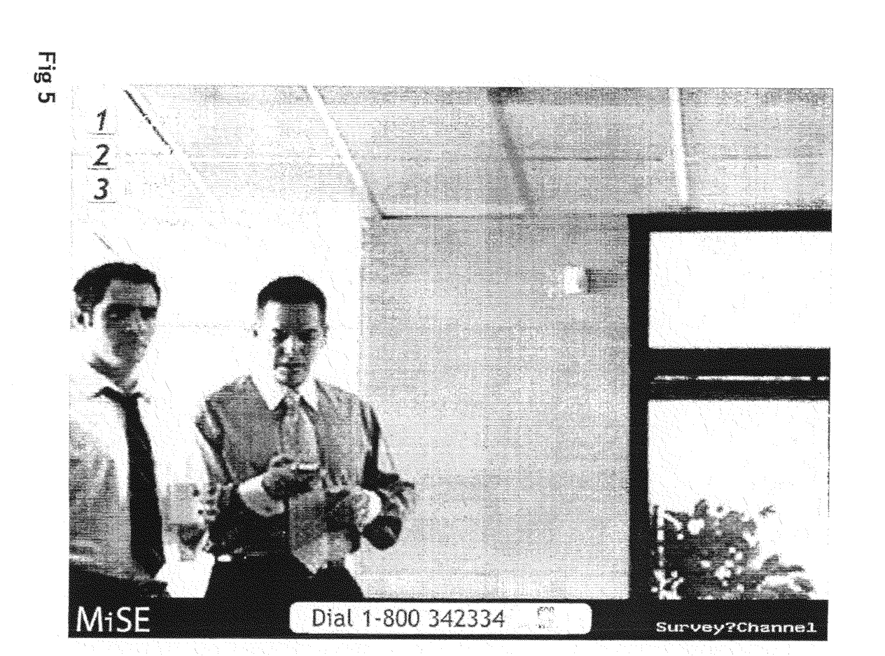

FIG. 5 shows a screen capture of a pilot TV show together with a callback telephone number that viewers would have to call before viewing the show, allowing them to indicate their degree of satisfaction or dissatisfaction.

It is a particular feature of the technology disclosed herein, in that dedicated feedback devices are not required. Target audiences are able to sit at home at a designated time, view a broadcast and freely indicate their satisfaction/dissatisfaction by pressing keys on their telephone handsets. For example, entertainment value may be rated on a scale of 1 to 5, with 1 indicating that the program is boring, 2 indicating that it is poor, 3 indicating that it is OK, 4 indicating that it is entertaining, and 5 indicating WOW!. The digits 1 to 5 are inputted using the number pad of the telephone handsets, typically mobile phones, thereby allowing a number of viewers watching the same TV set to participate. Cues in the show can be added to generate responses to particular sections or features, perhaps likeability or believability of particular characters, for example. The responses to such cues, may be collected and analysed statistically.

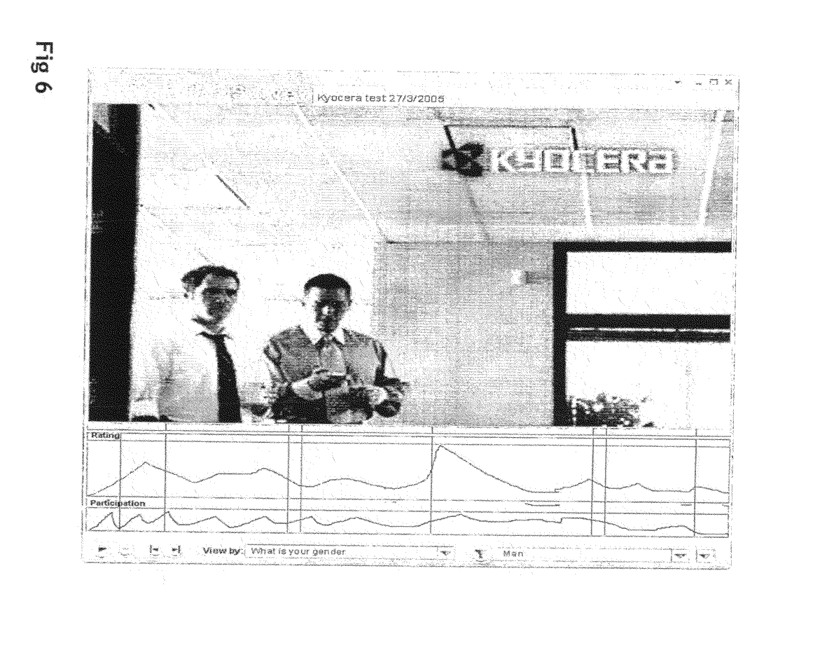

FIG. 6 shows a playback of the pilot TV show together with a chart that is synchronized therewith, in which the aggregated satisfaction of the viewing audience is depicted, and their participation rate in terms of the percentage of the survey participants pressing on a button at any one time. It will be appreciated that this provides a powerful tool that may be used by TV show directors, by purchasing and scheduling personnel, and the like.

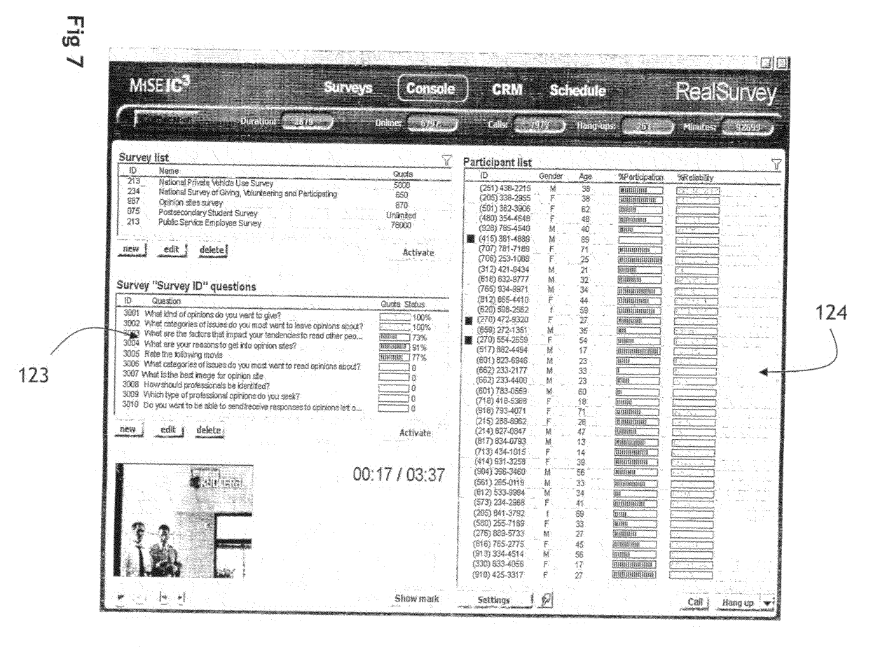

Research surveys may include basic demographic questions, the answers to which can be validated by truthfulness indicators to filter false participants. Consumer research surveys that require controlled target population are able to utilize the survey participant registry 117 to select an appropriate audience. By way of example, FIG. 7 shows an exemplary Survey Management Console screen 122 with a pane 123 showing the percentage of survey participants compared to the intended number of survey participants for a particular question. The Survey Management Console screen 122 includes a pane 124 showing % participation and % reliability of survey participants registered in the Survey Participant Registry 117. The Result Analysis Module 112 enables survey organizers to define a result set, apply analysis tools and export the information to third party analysis tools.

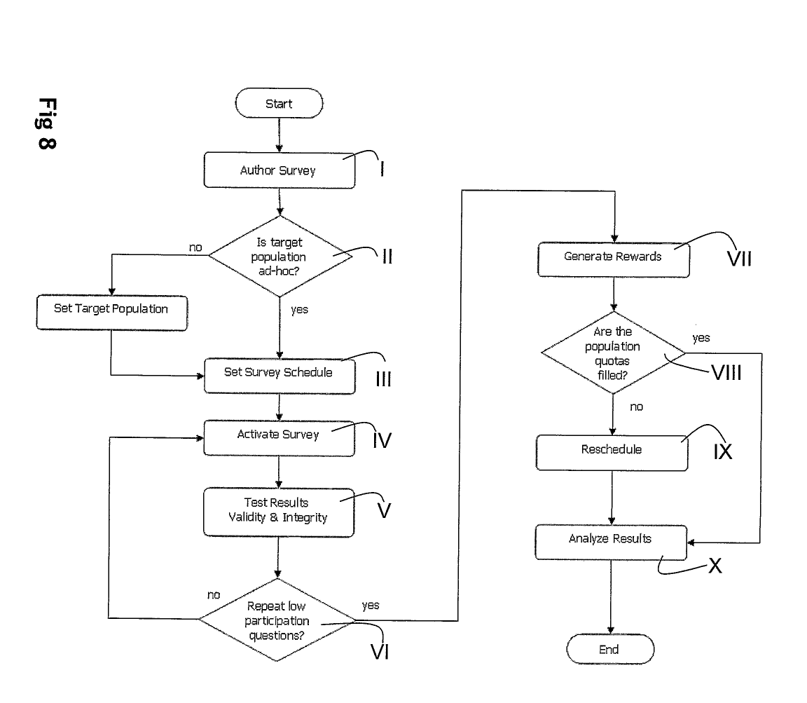

FIG. 8 is a flowchart that provides an overall view of the operation of the Consumer Research Survey Management Apparatus 100 for holding surveys: A survey organizer authors a survey (Step I) and determines whether the target population is ad-hoc or a set target (Step II). The survey organizer then sets the survey schedule (Step III) and activates the survey (Step IV). The survey organizer monitors the survey in terms of its validity and integrity (Step V) and also monitors participation levels (Step VI). The survey organizer may award incentives to survey participants (step VII). The survey organizer ensures that the survey matches the research requirements in terms of population quotas (Step VIII) and further ensures that the demographic profile of the survey participants matches the research requirements (Step IX). Portions or even an entire survey may have to be repeated (Step X). The results are then analyzed (Step XI).

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A Consumer Research Survey Management Apparatus comprising:
A Survey Management Console interfaced with a Survey Participant Response Machine through which results of survey participation are collected and processed.

2. The Consumer Research Survey Management Apparatus of claim 1, wherein the Survey Management Console interfaces with a Results Processor and a Survey Participant Registry.

3. The Consumer Research Survey Management Apparatus of claim 2, wherein the Results Processor includes a Results Repository and a Rewards Repository.

4. The Consumer Research Survey Management Apparatus of claim 2, wherein the Survey Participant Registry comprises a list of people who have consented to participate in surveys and have provided validated demographic information.

5. The Consumer Research Survey Management Apparatus of claim 1, further comprising a Broadcast Graphic Overlay Interface for generating and modifying graphic overlays that are addable to broadcast TV signals to provide participation cues and information to viewers.

6. The Consumer Research Survey Management Apparatus of claim 5, said viewers comprising survey participants.

7. The Consumer Research Survey Management Apparatus of claim 1, wherein the Survey Participant Response Machine 103 is hosted on at least one computer server capable of handling extensive communication bandwidth and processing requirements.

8. The Consumer Research Survey Management Apparatus of claim 1, wherein the Survey Participant Response Machine comprises both standard IP interfaces for connecting to Internet and to private IP networks and specialized interfaces for connecting to telephony and digital cable networks.

9. The Consumer Research Survey Management Apparatus of claim 1, wherein the Survey Management Console has a modular construction and includes modules selected from the list of:
An Authoring Module;
A Scheduling Module,
A Survey Participant Incentive Module;
A Target Population Control Module;
an Integrity and Validation Control Module, and
A Results Analysis Module.

10. The Consumer Research Survey Management Apparatus of claim 9, the Survey Management Console comprising an Authoring Module for providing survey organizers with an authoring environment for authoring surveys according to their requirements.

11. The Consumer Research Survey Management Apparatus of claim 9, the Survey Management Console comprising a Target Population Control Module that allows research surveys to be addressed to populations selected from the list of ad-hoc, predetermined and controlled target populations.

12. The Consumer Research Survey Management Apparatus of claim 9, the Survey Management Console comprising a Scheduling Module that enables the planning, monitoring and controlling of the delivery of consumer research surveys.

13. The Consumer Research Survey Management Apparatus of claim 12, wherein the Scheduling Module enables consumer research providers to establish a broadcast schedule in which consumer research surveys can be listed and repeated a number of repetitions.

14. The Consumer Research Survey Management Apparatus of claim 12, wherein the Scheduling Module schedules transmission of surveys within an existing, scheduled broadcast.

15. The Consumer Research Survey Management Apparatus of claim 12, wherein the Scheduling Module schedules transmission of surveys on a dedicated research channel.

16. The Consumer Research Survey Management Apparatus of claim 1, for facilitating the holding of surveys and having functionality for authoring surveys, managing target populations, scheduling surveys, managing survey participant incentives, and for integrity and validation control and result analysis.

17. The Consumer Research Survey Management Apparatus of claim 1, including automatic tools for aggregating the results from multiple broadcasts while maintaining population validity in terms of parameters selected from the list of demographics, quantity, quality and participant validity in terms of truthfulness.

18. The Consumer Research Survey Management Apparatus of claim 9, the Survey Participant Incentive Management Module for enabling incentives to be integrated into the Consumer Market Survey Management Apparatus.

19. The Consumer Research Survey Management Apparatus of claim 18, said incentives selected from the list of:
(i) rewards offered to participants based on qualitative and quantitative indicators of participation;
(ii) improved rewards offered to truthful participants who answer all questions;
(iii) rewards raffled between all participants;
(iv) rewards raffled between participants from specific participation groups;
(v) rewards adjusted and modified for registered participants based on their overall participation over a period of time.

20. The Consumer Research Survey Management Apparatus of claim 18, such that reports are generated and relayed to an actual payment distribution system for making payments.

21. The Consumer Research Survey Management Apparatus of claim 21, such that reports are generated according to parameters selected from the list of surveys, participants, participant groups and time periods.

22. The Consumer Research Survey Management Apparatus of claim 18, such that details of rewards are accumulated in a database for use in generating total reports.

23. The Consumer Research Survey Management Apparatus of claim 22, wherein said total reports are selected from the list of total reward per participant, total reward per participant group, total reward per survey by researcher and total reward per customer.

24. The Consumer Research Survey Management Apparatus of claim 9, the Survey Integrity & Validation Module for providing real-time monitoring and control tools for ensuring the integrity and validity of surveys.

25. The Consumer Research Survey Management Apparatus of claim 24, the tools being selected from the list of real-time indicators of truthfulness and completion for both participants and participant groups; real-time statistics such as number of participants in current screening; number of accumulated participants, and participation demographic statistics compared to research requirements.

26. The Consumer Research Survey Management Apparatus of claim 24, the tools including participants management tools for disconnecting untruthful participants from the Consumer Research Survey Management Apparatus and for identifying and filtering out repeat participants across numerous screenings.

27. The Consumer Research Survey Management Apparatus of claim 24 wherein real-time demographic information on accumulated participants is usable to adjust the demographic requirements for future runs.

28. The Consumer Research Survey Management Apparatus of claim 24 wherein Research Management Tools are provided that enable the research survey delivery to be altered in real-time, either through operator intervention or automatically, in response to participation indicators and results.

29. The Consumer Research Survey Management Apparatus of claim 1 wherein filtering and qualifying of answers to be added to the result-set include aggregated indicator information selected from the list of individual survey participants and survey participant groups.

30. The Consumer Research Survey Management Apparatus of claim 29 wherein filters and result-sets are savable for reuse.

31. The Consumer Research Survey Management Apparatus of claim 1 wherein analysis tools are provided for creating and testing indicators for specific panelists.

32. The Consumer Research Survey Management Apparatus of claim 1 wherein analysis tools are provided for creating and testing indicators for entire populations.

33. The Consumer Research Survey Management Apparatus of claim 1 for conducting surveys selected from the list of quantitative surveys wherein participants are required to respond to an extensive questionnaire, and rating surveys, where targeted, queried consumers provide information regarding their actual television viewing at time of querying.

34. The Consumer Research Survey Management Apparatus of claim 1 wherein queries are displayed on a TV screen during viewing of a broadcast program and responses are provided by responding viewers using their mobile phones.

35. The Consumer Research Survey Management Apparatus 1 for transmitting surveys, said surveys being adjustable during their transmission.

36. A method for holding surveys using the Consumer Research Survey Management Apparatus of claim 1, comprising the steps of authoring a survey (Step I); determining whether the target population is ad-hoc or a set target (Step II); setting the survey schedule (Step III); activating the survey (Step IV); monitoring the survey in terms of its validity and integrity (Step V) monitoring participation levels (Step VI); optionally awarding incentives to survey participants (step VII); ensuring that the survey matches the research requirements in terms of population quotas (Step VIII) ensuring that the demographic profile of the survey participants matches the research requirements (Step IX); repeating at least part of the survey if necessary (Step X) and analyzing results (Step XI).
